(19) United States
(12) Patent Application Publication
(10) Pub. No.: US 2006/0260825 A1
(43) Pub. Date: Nov. 23, 2006

(54) Flap-plate flame arrestor

(75) Inventor: Kenneth W. Cannell, Yuma, AZ (US)

Correspondence Address: QUARLES & BRADY STREICH LANG, LLP, ONE SOUTH CHURCH AVENUE, SUITE 1700, TUCSON, AZ, 85701-1621, US

(73) Assignee: Gowan Milling Company, L.L.C., Yuma, AZ (US)

(21) Appl. No.: 11/090,684

(22) Filed: Mar. 25, 2005

(51) Int. Cl. A62C 8/00

(52) U.S. Cl. 169/48; 169/49; 169/50

(57) ABSTRACT

A flame arrester uses two flap plates mounted at the center of its housing to prevent the propagation of a flame front caused by the deflagration of a flammable fluid. During the normal flow of fluid, the flap plates are open with a small gap between them facing the direction of flow. When a deflagration occurs, the pressure wave that precedes the flame front is caught by the gap between the two flap plates and pushing them to a closed poison against a circular stop ring in the wall of the housing, thereby preventing the propagation of the flame front.

### BACKGROUND OF INVENTION

1. Field of Invention

The invention relates to the containment of flammable gases and liquids and more specifically to the isolation and suppression of a flame front from deflagration of flammable gases, suspensions, or liquids.

2. Description of the Related Art

During the use and storage of flammable gases, suspensions, and liquids, there is always a risk of the propagation of deflagration or explosion. When a deflagration occurs inside a containment structure, it produces a pressure wave and a flame front that travel along a conduit and can reach storage tanks, engines or other machinery causing additional eruptions. To isolate the wave, flame arresters are placed along the pipe to prevent the wave from reaching other equipment or storage areas by localizing the flame front and keeping it from continuing through successive communicating conduits. Flame arresters are designed to allow the flow of gases or liquids in one direction under normal operating conditions but prevent a flame front or backfire from traveling in the opposite direction following an explosion.

Flame arrestors are used in many applications such as factory equipment, water heaters, dryers, and internal combustion engines. Due to the high number of different applications, there are many types of flame arresters. The most common type is exemplified in U.S. Pat. No. 5,415,233, issued it Roussakis et al. This type of flame arrester includes an element that dissipates the flame front of a deflagration. The element is attached to the conduit transporting the flammable material and is made of successive layers of steel mesh or crimped ribbon oriented to create channels that allow flammable gas or liquid to flow through. As a flame front traveling in the opposite direction reaches the element, the small channels remove heat from the front and extinguish it. One problem with this approach is that the element restricts the flow of the flammable material and creates significant back pressure. To relieve this problem, the element is provided in a diameter greater than that of the conduit, thereby increasing the cross-section available for flow through the flame arrester. Another problem is the fact that the small channels of the flame arrester sometimes do not completely extinguish the flame front.

A different type of flame arrester is disclosed in U.S. Pat. No. 5,402,603 to Henley. Instead of dissipating the flame front with a mesh or a spiral crimp ribbon structure, the arrester utilizes interior flap plates that close when reached by the propagating front. The closure of the flaps is triggered by the deflagration wave that precedes the explosion, thereby preventing its propagation up the conduit. The flaps are hinged to the interior surface of the arrester structure and close toward the center. In one embodiment, a hook and loop mechanism holds the flaps in open position and releases them when triggered by the deflagration wave. Another embodiment utilizes pervious flame arresters, Henley's utilizes a middle chamber with a greater diameter than that of the associated conduit to relieve the pressure drop created by the presence of the internal flaps and the triggering mechanism.

One drawback of this design is that the flaps are attached to the interior wall of the enlarged portion of the arrester and are, therefore, not directly in the flow path of the fluid flowing from the smaller conduit. This limits the ability of the flaps to fully catch the pressure wave front and close rapidly following an explosion. In addition, because the flaps are attached to the interior surface of the flame arrester, they can be fully opened only if the arrester is of a shape (such as rectangular) that permits their parallel alignment with the walls of the arrester. The present invention discloses a modified approach that reduces back pressure, produces more effective closure of the arrestor flaps, and is suitable for implementation in arresters with any cross-sectional shape.

### SUMMARY OF INVENTION

One objective of the invention is to provide a flame arrester that closes a conduit and prevents the propagation of a pressure wave in a more effective way.

Another objective is a flame-arrester design suitable for implementation with both rectangular and cylindrical arrester structures.

The preferred embodiment of the invention includes a housing with a cylindrical chamber of greater diameter than the flow conduits for which it is intended. Accordingly, the structure of the flame arrester includes two inwardly slanted ends converging and connected to the conduit. A shaft is mounted diametrically across the chamber and two flap plates are pivotally attached to it, so that the flaps may be opened and closed symmetrically. A stop ring is provided to prevent the flap plates from pivoting past their closed position within the cylindrical chamber.

During normal operations, the flap plates are kept open with the direction of flow in substantial alignment with the center line of the arrester, so as to permit flow with a minimal amount of drag. However, a small opening is maintained between the two flap plates facing the direction opposite to the flow in order to catch a pressure wave traveling in the opposite direction. Because of the flow obstruction produced by the shaft, the flap plates, and the angle maintained between them, an undesirable pressure drop is introduced into the system. Therefore, the diameter of the cylindrical chamber is preferably greater than that of the conduit ends to which it is attached.

When a deflagration of flammable material occurs, the resulting pressure wave preceding the flame front travels in all open directions, including the direction opposite to the material flow. According to the invention, when the wave reaches the front edges of the slightly opened flap plates in its backward travel following a deflagration, the wave causes the flap plates to immediately swing to their closed position and seal the chamber to any back flow against the stop ring inside the housing. Preferably, latches hold the flap plates in the closed position. Thus, the flame front cannot continue through the flame arrester and its propagation is completely stopped, preventing further upstream explosions.

### BRIEF DESCRIPTION OF DRAWINGS

FIG. 1 is a perspective view of the preferred embodiment of the flame arrester of the invention with the interior flap plates shown in phantom line.

FIG. 2 is a schematic, partially cut-out, side elevational view of the flame arrester of FIG. 1 with the flap plates in normally open position.

FIG. 3 is a schematic, partially cut-out, side elevational view of the flame arrester of FIG. 1 with the flap plates in the closed position.

FIG. 4 illustrates in perspective view an alternative embodiment of the flame arrester of the invention with a rectangular housing and conforming rectangular flaps and sleeves on each end thereof.

### DETAILED DESCRIPTION OF THE INVENTION

The invention relates to a flame arrester that utilizes flap plates to prevent the propagation of the flame front produced by the deflagration of flammable material. In disclosing the invention, the flame arrester is described with reference to flammable gases, but it is understood that it can be used as well with flammable suspensions and liquids with various viscosities.

FIG. 1 illustrates in perspective view the preferred embodiment of a flame arrester 10 according to the invention. The flame arrester includes a housing 12 with a cylindrical chamber 14 and converging tubular ends 16. The chamber 14 is shown as a cylinder, but any shape with a symmetrical cross section, such as square or rectangular, would be equally suitable. The ends 16 on each side of the housing 12 have slanted walls converging inwardly on each side of the cylindrical chamber 14 toward a flange 18. The flange is used to connect each side of the flame arrester 10 to a conduit that carries the flammable fluid. The housing is preferably made of stainless steel to withstand the high pressures carried by the flame front resulting from the deflagration of a flammable fluid and to minimize corrosion, which could affect reliability.

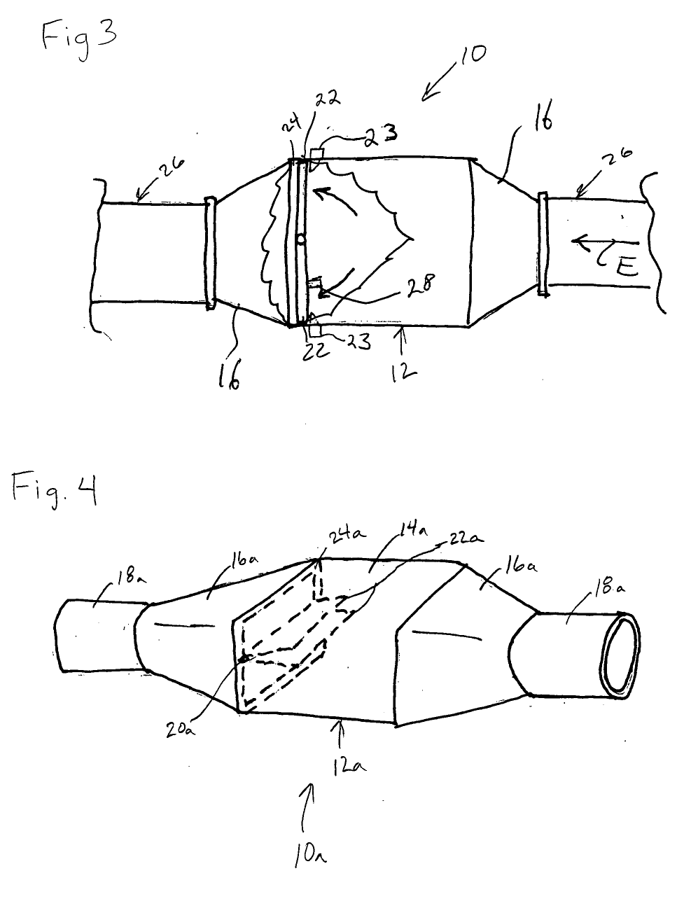

Also shown in FIG. 1 are the interior elements of the preferred embodiment of the invention. At the proximal end of the cylindrical chamber 14, past the expanding cone where the flammable fluid is introduced into the flame arrester as it flows in the direction of the arrow F, a shaft 20 is mounted diametrically across the longitudinal section of the housing 12. Pivotally attached to the shaft 20 are symmetrically disposed flap plates 22 that match the shape of the cross-section of the cylindrical chamber 14. Accordingly, as seen in the figure, each flap plate 22 is shaped as a semi-circle which, when the flaps are closed, forms a circular structure of substantially the same diameter as the interior of the chamber. Preferably, latch means 23 are disposed upon chamber 14 such that flap plates 22 are engaged while in the closed position (e.g., as shown in FIG. 3). Also included in the preferred embodiment is a stop ring 24 mounted within the interior of the cylindrical chamber 14 in cross-sectional alignment with the shaft 20 to provide a structure against which the flap plates 22 rest in closed position. The stop ring 24 extends from the interior of the housing 12 and prevents the flap plates 22 from rotating beyond the vertical plane. In the preferred embodiment, the shaft and the stop ring are mounted at one end of the cylindrical chamber, but they could be mounted anywhere within the chamber along any plane perpendicular to the main axis thereof, so long as the rotation of the flap plates toward their closed position is not obstructed.

As stated before, a necessary feature of the flame arrester is that it must allow consistent flow of the flammable fluid. In order to minimize the pressure drop created by the shaft and flap plates in the middle of the flame arrester, the cylindrical chamber containing the flap plates is provided with a larger diameter than the conduit on each side thereof, thereby increasing the cross-sectional area available for flow. The extent to which the diameter of the chamber is increased depends on the particular application for the flame arrester, the properties of the fluid being conveyed, and correspondingly on the amount of back pressure created by the internal parts of the flame arrester. For example, in the case where the invention is used with 8-inch steel conduit to transport a dust suspension in air, an increase to about 10 inches in the diameter of the chamber produces substantially the same linear pressure drop in the arrester as along the conduit.

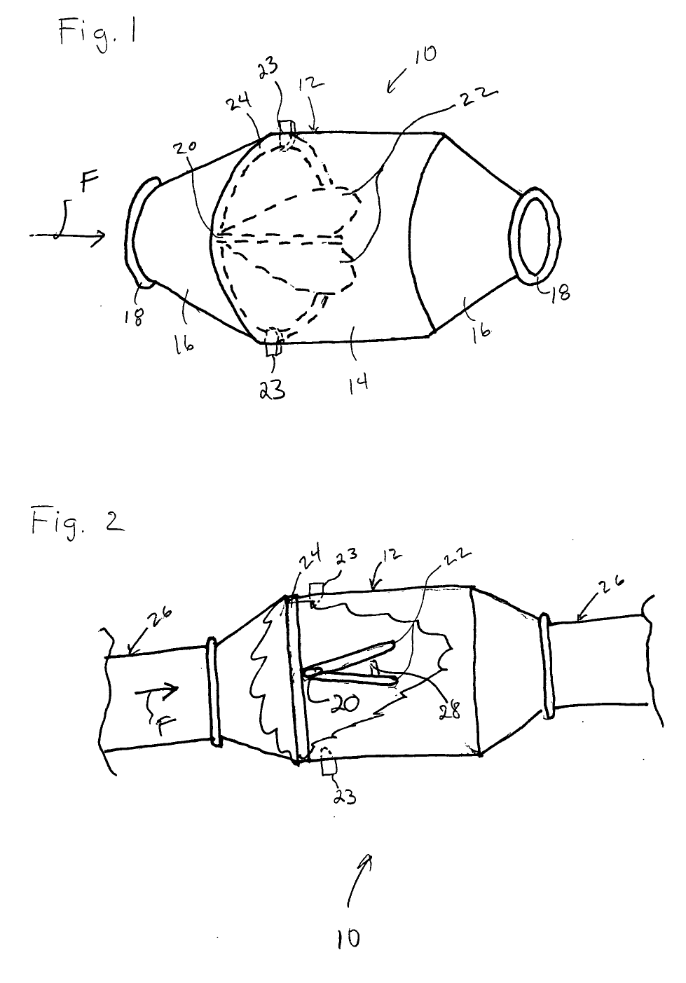

FIG. 2 illustrates the operation of the preferred embodiment as a flammable fluid passes through, wherein elements identical to those found in FIG. 1 are denoted with like numbers. The flame arrester 10 is connect to a conduit 26 used to transport flammable fluids and is placed preferably within about 5 feet from where a deflagration is likely to occur. As the fluid flows in the direction of the arrow F, the flap plates 22 are pushed in the same direction to form a V-shaped baffle structure at the center of the housing 12 with a narrow angle maintained between the two flap plates. A spacer 28 or other equivalent mechanism is used to maintain a minimum angle and ensure that any back pressure caused by an deflagration would catch the front side of the flap plates and force them to a closed position. In order to ensure that the deflagration flame traveling in the direction opposite to the fluid flow is caught and arrested by the flap plates 22, an angle of sufficient degrees must be maintained between the flap plates for a very rapid response, preferably, at least 30 degrees. This angle produces a relatively low obstruction and pressure drop, so that the flammable fluid may flow freely through the flame arrester.

FIG. 3 illustrates the operation of the flame arrester when a deflagration occurs. Because of the slight opening between the flap plates 22, the pressure wave that precedes the flame traveling in the direction of the arrow E triggers their closure. As a result, the plates 22 are engaged by latch means 23 and pushed against the stop ring 24 inside the housing 12 and backflow is completely stopped. Accordingly, the flap plates close the flame arrester and prevent the flame from continuing down the conduit and causing further damage or explosions.

FIG. 4 illustrates an alternative embodiment of the invention wherein the flame arrester 10a includes a housing 12a with a chamber 14a of rectangular—section configuration. The ends 16a are similarly rectangular in cross-section to conform to the chamber. Each end 16a tapers to a cylindrical sleeve 18a suitable for connection with the conduit to be attached to the flame arrester. For example, the sleeve may be placed over the conduit and attached by a weld or other coupling device.

The interior of the embodiment of the FIG. 4 is similarly equipped with a shaft 20a mounted across the section of the housing 12a in symmetrical arrangement. Two equal, rectangular flap plates 22a are pivotally mounted to the shaft 20a such that, in combination, they match the rectangular shape of the chamber 14a. A rectangular stop ring 24a is mounted along the interior surface of the rectangular chamber 14a, coplanar with the shaft, to prevent the flap plates 22a from rotating beyond the vertical plane.

Thus, a flame arrester has been described that is simple in construction, produces less pressure drop to flow, and is more responsive to back pressure for almost instantaneous closure than the ones found in the prior art. The concept of hinging the flap plates to a shaft running centrally across the section of the arrester, rather than to the interior wall of the arrester, allows the flaps to be positioned symmetrically substantially in the direction of flow, thereby minimizing drag. Also, because the flap plates are open at the center of the arrester, they are better positioned to catch the back pressure of the conduit along the walls. Therefore, maximum back pressure is exerted at the center and the flaps are closed more rapidly. Finally, the diametrically placed shaft requires the use of two flaps, rather than a single one hinged at the wall. Accordingly, the distance traveled by each of a pair of flaps is shorter than in the case of a single one, and the time required for closure is correspondingly faster. These features provide an improved flame arrester over the ones described in prior art.

Various changes in the details, steps and components that have been described may be made by those of ordinary skill in the art within the principles and scope of the invention herein illustrated and defined in the appended claims. For example, the invention has been illustrated in both the cylindrical and rectangular embodiments in terms of equal flap plates mounted symmetrically on a shaft disposed centrally across the center of the section of the arrester's chamber. However, in the rectangular embodiment the same result could be achieved with plates of different sizes mounted off the center of section, so long as they could still swing open in the direction of flow and swing closed to fully cover the section of the chamber. Therefore, while the present invention has been shown and described in what is believed to be the most practical and preferred embodiments, it is recognized that departures can be made therefrom within the scope of the invention, which is not to be limited to the details disclosed herein but is to be accorded to the full scope of the claims so as to embrace any and all equivalent apparatus and processes.

We claim:

1. A flame arrester for preventing propagation of a flame front produced by a flammable material flowing in a conduit, comprising:
a chamber with tapered ends adapted for connection to the conduit;
a shaft mounted in the chamber across a plane perpendicular to a direction of flow of said flammable material;
first and second flap plates pivotally mounted on the shaft, said flap plates being freely rotatable between an open position toward said direction of flow and a closed position substantially perpendicular to said direction of flow;
a means for limiting a motion of each of said first and second flap plates to said closed position when the flap plates rotate between the open and closed positions; and
a means for maintaining an opening between the flap plates in the open position;
whereby a pressure wave traveling in a direction opposite to said direction of flow causes the first and second flaps plates to rotate to said closed position and rest against said limiting means.

2. The flame arrester of claim 1, wherein said limiting means comprises a stop ring attached to an interior wall of the chamber.

3. The flame arrester of claim 1, wherein the chamber is cylindrical.

4. The flame arrester of claim 2, wherein the chamber is cylindrical.

5. The flame arrester of claim 1, wherein the chamber is rectangular and the shaft is disposed symmetrically across a section of the chamber.

6. The flame arrester of claim 1, wherein said opening between the flap plates in the opening position is at least 30 degrees.

7. The flame arrester of claim 2, wherein said opening between the flap plates in the open position is at least 30 degrees.

8. The flame arrester of claim 4, wherein said opening between the flap plates in the open position is at least 30 degrees.

9. The flame arrester of claim 5, wherein said opening between the flap plates in the open position is at least 30 degrees.

10. The flame arrester of claim 1, further including latching means disposed upon said chamber such that said first and second flap plates are engaged in the closed position.
